(19) United States
(12) Patent Application Publication
(10) Pub. No.: US 2011/0061501 A1
(43) Pub. Date: Mar. 17, 2011

(54) SIGNAL LOCK TOOL

(76) Inventor: Qun Jia, Yangzhou (CN)

(21) Appl. No.: 12/714,555

(22) Filed: Mar. 1, 2010

(30) Foreign Application Priority Data
Sep. 17, 2009 (CN) 200910034542.X

(51) Int. Cl. B25G 1/00

(52) U.S. Cl. 81/489

(57) ABSTRACT

The present patent application relates to a signal lock tool. The signal lock tool comprises a handle, a hollow rotating element, an eccentric tube and an eccentric shaft. The eccentric tube is fixedly secured to the rotatable element. The eccentric tube has an eccentric through hole defined therein. A protrusion portion is formed at one end of the eccentric shaft. The other end of the eccentric shaft is inserted into and extending through the eccentric through hole and the rotatable element to connect the handle. The eccentric through hole and the eccentric shaft are coaxial with each other. The present patent application simplifies the production process of the signal lock, saves production costs, and prevents the signal lock from being unlocked by a plier or a simple polishing tool, and also ensures the safety of the cable signal.

The present patent application claims priority to the Chinese application CN200910034542.X filed on 17 Sep., 2009, which is incorporated herein by reference.

### TECHNICAL FIELD

The present patent application relates to the telecommunication field, more particularly to a signal lock tool for wired signal transmission.

### BACKGROUND

A traditional wired signal lock usually has an inner groove. Generally, a spring lock tool or a slotting lock tool is used to unlock the wired signal lock. The ball and the key pin are used to unlock by twisting force and elastic biasing force, which may cause the ball and the key pin to be skidded so that the key pin may be broken due to the torque applied thereon. Most of these are affected by characteristics of the material, which bring instability to unlock. The above unlock way is complex, and the producing cost of the tool for unlocking is high, also the handling of the tool is difficult. Furthermore, the traditional signal lock usually has an inner groove, which involves many disadvantages, e.g., a plier or a simple polishing tool can be used to unlock the signal lock, which may lead to the problem that the signal is stolen.

### SUMMARY

It is an object of the present patent application to provide a signal lock tool which has a stable unlocking manner, a convenient handling and a high durability.

To solve the problems of the prior art, the present patent application provides a signal lock tool comprising a handle, a hollow rotatable element, an eccentric tube and an eccentric shaft. The eccentric tube is fixedly secured to the rotating element. The eccentric tube has an eccentric through hole defined therein. A protrusion portion is formed at one end of the eccentric shaft. The other end of the eccentric shaft is inserted into and extending through the eccentric through hole and the rotating element to connect the handle. The eccentric through hole and the eccentric shaft are coaxial with each other.

In one embodiment, the protrusion portion and the eccentric tube are cylindrical, and the outer diameter of the protrusion portion is greater than or equal to the outer diameter of the eccentric tube.

In one embodiment, the eccentric tube and the protrusion portion are coaxial with each other.

In one embodiment, the eccentric shaft is connected to the handle through a pin.

In one embodiment, the eccentric shaft and the eccentric through hole are fitted together with gaps therebetween.

In one embodiment, an annular knurl is formed on the surface of the protrusion portion.

In one embodiment, an annular knurl is formed at the surface of the eccentric tube corresponding to the protrusion portion.

In one embodiment, the eccentric tube and the rotating element are welded together or formed in an integrated manner.

In one embodiment, the signal lock comprises a hollow housing, a core member and a connecting head, the core member is received in the hollow housing, the connecting head is fixedly secured to the housing, the core member is movably mounted onto the hollow housing and the connecting part, and the core member has a circular hole formed thereon.

In one embodiment, the diameter of the circular hole is greater than the outer diameter of the protrusion portion.

The present patent application solves the problems of the prior art. The present patent application simplifies the production process of the signal lock, saves production costs, and keeps the signal lock from being unlocked by a plier or a simple polishing tool, and also ensures the safety of the cable signal. The present patent application enables repulsion between the tool and the core member, which ensures a stable locking and unlocking, the procedure being simple and easy to operate.

### BRIEF DESCRIPTION OF THE DRAWINGS

The present patent application will be described hereinafter in detail with embodiments and Figures.

FIG. 1 is a schematic view of a signal lock tool in accordance with a preferred embodiment of the present patent application.

FIG. 2 is a schematic view of a signal lock tool in another status.

FIG. 3 shows a cross section according to line A-A in FIG. 1.

FIG. 4 is a schematic view of a signal lock.

FIG. 5 is a perspective view of a signal lock tool according to the present patent application.

1. handle; 2. rotating element; 3. eccentric tube; 31. eccentric through hole; 4. eccentric shaft; 41. protrusion portion; 5. housing; 6. core member; 61. circular hole; 7. connecting head; 8. pin

### DETAILED DESCRIPTION OF THE PATENT APPLICATION

The present patent application will be described hereinafter in detail with the Figures and preferred embodiments. The Figures show simplified basic structures of the present patent application.

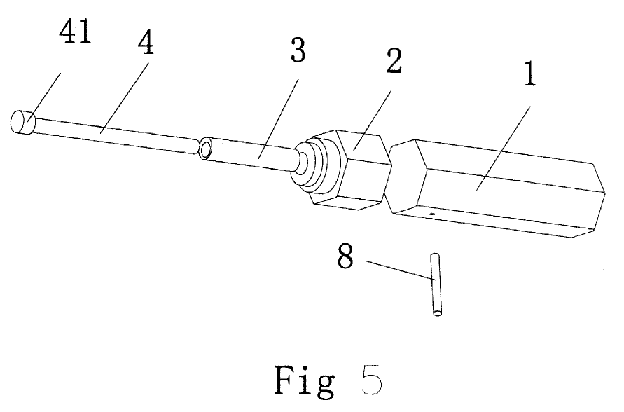

As shown in FIG. 1 and FIG. 5, a signal lock tool comprises a handle 1, a hollow rotating element 2, an eccentric tube 3 and an eccentric shaft 4. The eccentric tube 3 is fixedly secured to the rotatable element 2. The eccentric tube 3 has an eccentric through hole 31 defined therein. A protrusion portion 41 is formed at one end of the eccentric shaft 4. The other end of the eccentric shaft 4 is inserted into and extends through the eccentric through hole 31 and the rotatable element 2 to connect the handle 1. The other end of the eccentric shaft 4 is fastened to the handle 1. The eccentric through hole 31 and the eccentric shaft 4 are coaxial with each other. Preferably, the protrusion portion 41 and the eccentric tube 3 are cylindrical. The outer diameter of the protrusion portion is greater than or equal to the outer diameter of the eccentric tube 3. As shown in FIG. 4, the signal lock comprises a hollow housing 5, core member 6 and connecting head 7. The core member 6 is received in the hollow housing 5. The connecting head 7 is fixedly secured to the housing 5. The core member 6 is movably mounted onto the hollow housing 5 and the connecting part 7. The core member 6 has a circular hole 61 without groove formed thereon. Preferably, the diameter of the circular hole 61 is greater than the outer diameter of the protrusion portion 41.

To unlock efficiently, the eccentric tube 3 and the protrusion portion 41 are coaxial with each other. Advantageously, the eccentric shaft 4 is connected to the handle 1 through a pin 8. Furthermore, in order that the protrusion portion 41, the eccentric tube 3 and the circular hole 61 are connected with each other efficiently, the annular knurl is formed at the surface of the protrusion portion 41 and/or on the surface of the eccentric tube 3 corresponding to the protrusion portion 41.

In order that the eccentric tube 3 is connected with the rotating element 2 conveniently, in the present patent application, the eccentric tube 3 and the rotating element 2 are preferably welded together.

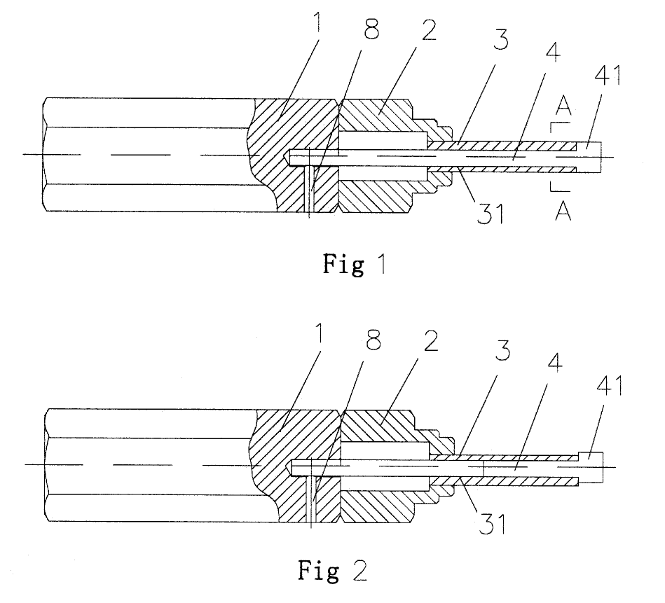

As shown in FIG. 2, when the rotatable element 2 rotates, the eccentric tube 3 is turned relative to the protrusion portion 41, which causes a deviation therebetween and a repulsion between the signal lock tool and the core member 6 with circular hole 61, which makes the tool and the core member fastened together.

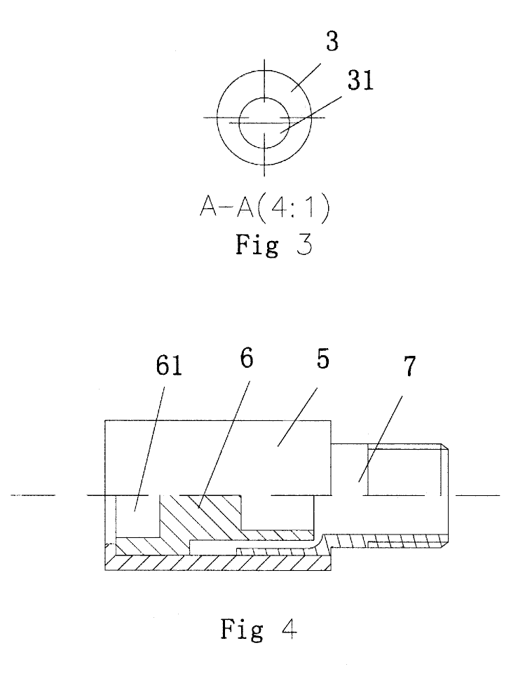

As shown in FIG. 3, the operating procedure of the present patent application is as follows:

Fastening steps:

First, insert the protrusion portion 4 of the tool into the circular hole 61 of the signal lock. Keep the handle 1 unmoved, turning the rotating element 2 clockwise, which causes the eccentric tube 3 and the protrusion portion 41 to move relative to each other, and a deviation is produced between the eccentric tube 3 and the protrusion portion 41. In FIG. 2, a repulsion is produced between the signal lock tool and the core member 6 with circular hole 61, which makes the tool and the core member 6 fastened together. In other words, the tool can drive the core member to connect with other signal device.

Unlock steps:

First, turn the rotating element 2 counter-clockwise, and then the eccentric tube 3 and the protrusion portion 4 will rotate relative to each other. The eccentric tube 3 and the protrusion portion 4 are coaxial with each other, which will release the repulsion, i.e., the opposing force between the tool and the core member 6, thereby enabling unlocking of the tool and the core member 6. In other words, the tool can drive the core member to be disconnected from other signal device.

The present patent application has now been described with the exemplary embodiment. Modifications or changes may be made to the exemplary embodiments without deviation from the inventive concepts of the present patent application.

I claim:

1. A signal lock tool, comprising a handle, a hollow rotating element, an eccentric tube and an eccentric shaft, wherein the eccentric tube is fixedly secured to the rotating element, the eccentric tube has an eccentric through hole defined therein, a protrusion portion is extended at one end of the eccentric shaft, the other end of the eccentric shaft extends through the eccentric through hole and the rotatable element to connect the handle, and wherein the eccentric through hole and the eccentric shaft are coaxial with each other.

2. A signal lock tool according to claim 1, wherein the protrusion portion and the eccentric tube are cylindrical, and the outer diameter of the protrusion portion is greater than or equal to the outer diameter of the eccentric tube.

3. A signal lock tool according to claim 1, wherein the eccentric tube and the protrusion portion are coaxial with each other.

4. A signal lock tool according to claim 1, wherein the eccentric shaft is connected to the handle through a pin or by means of punching.

5. A signal lock tool according to claim 3, wherein the eccentric shaft and the eccentric through hole are fitted together with gaps therebetween.

6. A signal lock tool according to claim 3, wherein a knurl is formed on the surface of the protrusion portion.

7. A signal lock tool according to claim 3, wherein the knurl is formed on the surface of the eccentric tube corresponding to the protrusion portion.

8. A signal lock tool according to claim 1, wherein the eccentric tube and the rotatable element are welded together or formed in an integrated manner.

9. A signal lock tool according to claim 1, wherein the signal lock comprises a hollow housing, a core member and a connecting head, wherein the core member is received in the hollow housing, the connecting head is fixedly secured to the housing, the core member is movably mounted onto the hollow housing and the connecting part, and the core member comprises a circular hole.

10. A signal lock tool according to claim 1, wherein the diameter of the circular hole is greater than the outer diameter of the protrusion portion.

11. A signal lock tool according to claim 2, wherein the eccentric tube and the protrusion portion are coaxial with each other.

12. A signal lock tool according to claim 11, wherein the eccentric shaft and the eccentric through hole are fitted together with gaps therebetween.

13. A signal lock tool according to claim 11, wherein a knurl is formed on the surface of the protrusion portion.

14. A signal lock tool according to claim 11, wherein the knurl is formed on the surface of the eccentric tube corresponding to the protrusion portion.
